(19) United States
(12) Patent Application Publication
(10) Pub. No.: US 2026/0318434 A1
(43) Pub. Date: Oct. 15, 2026

(54) ANGLE VALVE FOR WASHING MACHINE SUPPLY AND DRAIN BOX

(71) Applicant: TAIZHOU JIN QUAN COPPER CO., LTD., YUHUAN (CN)

(72) Inventor: CAIYOU SUN, YUHUAN (CN)

(21) Appl. No.: 19/290,621

(22) Filed: Aug. 5, 2025

(30) Foreign Application Priority Data
Apr. 11, 2025 (CN) 202520686969.2

(51) Int. Cl. F16K 27/06; D06F 39/08; F16K 27/12

(52) U.S. Cl. CPC F16K 27/067; D06F 39/08; F16K 27/12

(57) ABSTRACT

Disclosed is an angle valve for a washing machine supply and drain box, belonging to the technical field of pipe fittings. The angle valve includes a valve body. The valve body has a water inlet and a water outlet. An outside of the valve body has a protrusion. A mounting cover is arranged outside the protrusion. The mounting cover includes a cover plate I and a cover plate II that are detachably connected. The cover plate I is provided with two snap-fit protrusions, and the cover plate II is provided with two limit blocks adapted to the two snap-fit protrusions. The snap-fit protrusions and the limit blocks are configured to be fitted to limit the cover plate I and the cover plate II, and the cover plate I and the cover plate II are fitted to limit the protrusion.

### TECHNICAL FIELD

The present disclosure belongs to the technical field of pipe fittings, and in particular to an angle valve for a washing machine supply and drain box.

### BACKGROUND

For some American residents, water supply and drain lines for sinks, wash basins and washing machines in their homes are often connected to the wall through a supply and drain box (or outlet box) for users' management and maintenance.

For example, U.S. Pat. No. US11674292B2 discloses a modular plumbing box system and methods of mounting the same. This modular plumbing box system includes a supply box and a drain box. A bottom of the supply box is provided with two openings, and angle valves are respectively mounted in the two openings. The two angle valves are respectively configured to control the supply of cold water and hot water to a washing machine. An inner wall of the drain box is provided with a drain opening for mounting a drain line of the washing machine.

U.S. Pat. No. US7270144B2 disclose a universal washing machine outlet box. Specifically, valve mount inserts for insertion of angle valves are provided in openings in an inner wall of the outlet box. In order to ensure the mounting stability of the angle valves in the valve mount inserts, it is still necessary to mount a nut below the valve mount insert to limit the angle valve, so that the nut and the protrusion on the angle valve can be fitted to clamp the valve mount insert, thereby mounting the angle valve in the outlet box.

The above technical solutions have at least the following defects: Tightening the valve mount insert in the opening of the outlet box still needs a nut to limit the angle valve in the up-down direction, so as to prevent the angle valve from being directly pulled out of the valve mount insert. This mounting of the angle valve not only needs many components, but also needs to manually rotate the nut to make it threadedly connected to the angle valve. In addition, since the user needs to rotate the handwheel of the angle valve to open or close the angle valve, prolonged use tends to loosen the nut. As a result, the fit between the valve mount insert and the nut cannot completely limit the angle valve circumferentially. When the user rotates the handwheel, the angle valve may rotate with the handwheel. In other words, this fitting and assembling manner of the valve mount insert and the angle valve still needs to be improved.

### SUMMARY

In view of the above problems in the prior art, an objective of the present disclosure is to provide an angle valve for a washing machine supply and drain box. The technical problem to be solved by the present disclosure is how to optimize the mounting of an angle valve in a supply and drain box.

The above technical objective of the present disclosure can be achieved by the following technical solutions:

An angle valve for a washing machine supply and drain box includes a valve body. The valve body has a water inlet and a water outlet. An outside of the valve body has a protrusion. A mounting cover is arranged outside the protrusion. The mounting cover is configured to connect the valve body to an inside of a washing machine supply and drain box. The mounting cover includes a cover plate I and a cover plate II that are detachably connected. The cover plate I is provided with two snap-fit protrusions, and the cover plate II is provided with two limit blocks adapted to the two snap-fit protrusions. The snap-fit protrusions and the limit blocks are configured to be fitted to limit the cover plate I and the cover plate II, and the cover plate I and the cover plate II are fitted to limit the protrusion.

According to the above technical solution, the mounting cover is divided into the cover plate I and the cover plate II, which form a whole after the snap-fit protrusions are snap-fitted with the limit blocks, and the cover plate I and the cover plate II clamp the protrusion, so that the mounting cover and the valve body form a whole component. Compared with the prior art, the angle valve of the present disclosure and the mounting cover can be assembled quickly without an additional mounting tool, and the cover plate I and the cover plate II can limit the protrusion, so that the valve body cannot rotate relative to the mounting cover or slide up and down, and the valve body and the mounting cover can be connected more firmly. After being assembled, the mounting cover and the valve body can be mounted as a whole component into the washing machine supply and drain box, which facilitates mounting for workers.

In the above angle valve, an inside of the cover plate I has a groove I, and an inside of the cover plate II has a groove II. Side walls of the groove I and the groove II are adapted to an exterior shape of the protrusion. The cover plate I and the cover plate II are combined to clamp the protrusion, and the groove I and the groove II are fitted to limit the protrusion. An outer wall and upper and lower sides of the protrusion are all surrounded by the groove I and the groove II, so that the mounting cover cannot rotate relative to the valve body or slide up and down, thereby realizing a complete limit between the mounting cover and the valve body without looseness.

In the above angle valve, a side surface of the cover plate I is provided with at least one positioning groove. The cover plate II is provided with a positioning column adapted to the positioning groove. The positioning column is inserted into the positioning groove to limit the cover plate I and the cover plate II. During the process in which the cover plate I is snap-fitted with the cover plate II, the positioning column is inserted into the positioning groove, which further guides the snap-fit between the cover plate I and cover plate II, effectively prevents the cover plate I and the cover plate II from dislocation or shaking, and ensures the stability of the cover plate I and the cover plate II after being connected.

In the above angle valve, at least two convex ribs are circumferentially distributed on an outer wall of the positioning column, and the positioning column abuts against a wall of the positioning groove through the convex ribs. The positioning column contacts the positioning groove through the convex ribs, which can lower the machining accuracies of the positioning column and the positioning groove. As long as the convex ribs can keep an interference fit with the positioning groove, the shaking after the cover plate I and the cover plate II are connected can be avoided.

In the above angle valve, a lower end of the cover plate I has a half ring I, and a lower end of the cover plate II has a half ring II. Inner sides of both the half ring I and the half ring II are configured to abut against an outer wall of the valve body. After the cover plate I and the cover plate II are combined into the complete mounting cover, the inner sides of both the half ring I and the half ring II abut against the outer wall of the valve body, which further prevents the valve body from shaking in the mounting cover in the left-right and front-rear directions and improves the stability between the mounting cover and the valve body.

In the above angle valve, an outer side of the half ring I is provided with a half ring III, and an outer side of the half ring II is provided with a half ring IV. Ribs I are arranged between the half ring I and the half ring III, and ribs II are arranged between the half ring II and the half ring IV. An outer wall of the half ring III is provided with a wedge I, and an outer wall of the half ring IV is provided with a wedge II. The ribs I improve the structural strength between the half ring I and the half ring III, and correspondingly, the ribs II improve the structural strength between the half ring II and the half ring IV. The wedge I and the wedge II are configured to snap into the washing machine supply and drain box by rotation.

In the above angle valve, the valve body is further provided with a mounting opening in communication with the water inlet and the water outlet. A water hammer arrestor is arranged in the mounting opening. The water hammer arrestor includes a connector, a casing and a piston. The connector is arranged in the mounting opening. A lower end of the casing is connected to the connector, and the connector communicates the lower end of the casing with an inside of the valve body. An upper end of the casing is sealed by an end cover. The end cover and an inside of the casing are sealed by a sealing gasket. The piston is slidably arranged in the casing. A cushioning member is arranged between the piston and the sealing gasket. A water hammer generated inside the valve body directly acts on the piston to force the piston to slide, and the cushioning member provides cushioning for the piston, thereby eliminating the damage of the water hammer to the valve body and ensuring the service life of the valve body. In addition, the sealing gasket can seal the possible gap between the end cover and the casing, which maintains the long-term air tightness inside the casing, thereby ensuring the service life of the water hammer arrestor.

In the above angle valve, a ball core is rotatably arranged in the valve body. The ball core is provided with a valve stem. An outer end of the valve stem runs through the valve body and is connected to a grip. The grip is detachably connected to an identification card. The identification card is configured to mark a type of a medium in the valve body. The ball core is controlled to rotate by the grip so as to control the opening and closing of the angle valve. The user can distinguish the type of the medium in the valve body through the identification card, which is convenient for the user to identify and operate. If the worker mounts the angle valve on a wrong water supply pipe such that the type of the medium in the valve body cannot correspond to the identification card, the worker only needs to replace the identification card with another identification card corresponding to the type of the medium in the valve body and does not need to dismount and remount the angle valve.

In the above angle valve, the grip has an assembly groove and an assembly hole that are in communication with each other. A wall of the assembly hole has a bump. The assembly groove is filled with the identification card. An inner side of the identification card is provided with a snap-fit foot. The snap-fit foot has a snap-fit hook. After the snap-fit foot is inserted into the assembly hole, the snap-fit hook is snap-fitted with the bump and limits the identification card. After the snap-fit foot is inserted into the assembly hole, the snap-fit hook is snap-fitted with the bump and limits the identification card in the assembly groove, thereby realizing the assembly of the identification card.

In the above angle valve, an outer wall of the identification card is flush with an outer wall of the grip, a side of the grip close to the identification card is provided with a notch, and the notch is configured to be inserted by a tool or a nail of a user. The identification card is flush with the outer wall of the grip, which ensures the integrated effect between the identification card and the grip and prevents the identification card from being separated abnormally. By inserting the tool or the nail of the user into the notch, the identification card can be taken out easily, so that the identification card can be mounted and dismounted conveniently.

Based on the above, compared with the prior art, the present disclosure has the following beneficial effects:
1. The angle valve of the present disclosure and the mounting cover can be assembled quickly and efficiently with low difficulty and without an additional mounting tool, and the cover plate I and the cover plate II can completely limit the protrusion, so that the valve body cannot rotate relative to the mounting cover or slide up and down, and the valve body and the mounting cover can be connected more firmly. After being assembled, the mounting cover and the valve body can be mounted as a whole component into the washing machine supply and drain box, which facilitates mounting. In addition, after the cover plate I and the cover plate II are connected, the mounting cover can be prevented from dislocation or shaking, and the cover plate I and the cover plate II can be connected more firmly. The mounting cover can also be directly used in combination with the existing angle valve. Since the mounting cover does not need to be sleeved on the protrusion from the lower end of the valve body, even if the diameter of the lower end of the valve body is greater than the external diameter of the valve body, the assembly of the cover plate I and the cover plate II with the valve body will not be affected, which makes the mounting cover have a wider application range.
2. The water hammer generated inside the valve body is eliminated by the water hammer arrestor. The sealing gasket can seal the possible gap between the end cover and the casing, which maintains the long-term air tightness inside the casing and ensures the service life of the valve body and the water hammer arrestor.
3. The identification card is configured for the user to accurately distinguish the type of the medium supplied in the valve body and to conveniently remove the identification card. Even if the worker mounts the angle valve on a wrong water supply pipe such that the identification card cannot correspond to the type of the medium in the valve body, the worker only needs to replace the identification card with a correct one, which can effectively make up for the influence on routine operation brought to users by the workers' mistaken mounting.

### BRIEF DESCRIPTION OF FIGURES

FIG. 1 is a schematic external structural view of an embodiment;

FIG. 2 is a schematic structural exploded view of FIG. 1;

FIG. 3 is a schematic sectional view of a valve body;

FIG. 4 is a schematic structural view of a cover plate I;

FIG. 5 is a schematic structural view of a cover plate II;

FIG. 6 is a schematic structural exploded view of a mounting cover;

FIG. 7 is a schematic structural view of FIG. 6 after combination;

FIG. 8 is a schematic sectional view I of an embodiment;

FIG. 9 is a schematic sectional view II of an embodiment;

FIG. 10 is a schematic partial sectional view of an embodiment;

FIG. 11 is a schematic sectional view of a grip;

FIG. 12 is a schematic structural exploded view of a grip and an identification card;

FIG. 13 is a schematic sectional view of a water hammer arrestor; and

FIG. 14 is a schematic structural view showing the assembly of a valve body and a washing machine supply and drain box.

Reference numerals: 1, washing machine supply and drain box;

100, valve body; 110, water inlet; 120, water outlet; 130, mounting opening; 140, protrusion; 150, ball core; 160, valve stem; 170, grip; 171, assembly groove; 172, assembly hole; 1721, bump; 173, notch;

200, mounting cover;

300, cover plate I; 310, snap-fit protrusion; 320, groove I; 330, positioning groove; 340, half ring I; 350, half ring III; 351, wedge I; 360, rib I; 370, flange;

400, cover plate II; 410, limit block; 420, groove II; 430, positioning column; 431, convex rib; 440, half ring II; 450, half ring IV; 451, wedge II; 460, rib II;

500, water hammer arrestor; 510, connector; 520, casing; 521, end cover; 530, piston; 540, sealing gasket; 541, accommodating groove; 550, cushioning member;

600, identification card; 610, snap-fit foot; and 611, snap-fit hook.

### DETAILED DESCRIPTION

The technical solutions of the present disclosure will be further described with reference to the specific embodiments of the present disclosure and accompanying drawings, but the present disclosure is not limited to these embodiments.

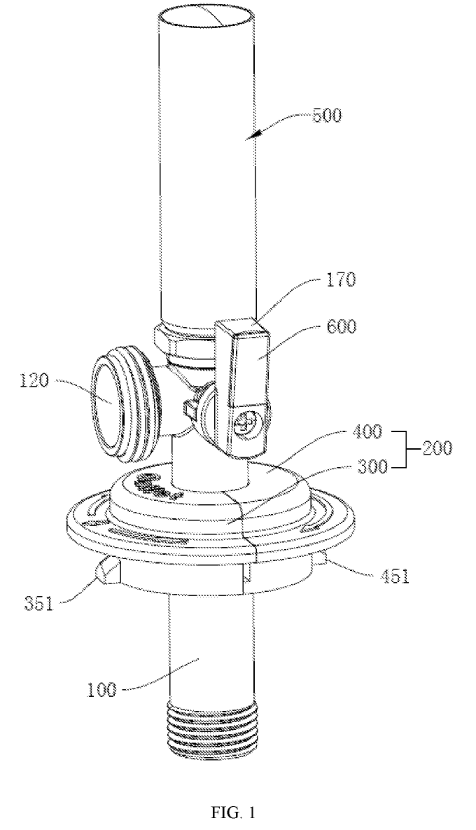

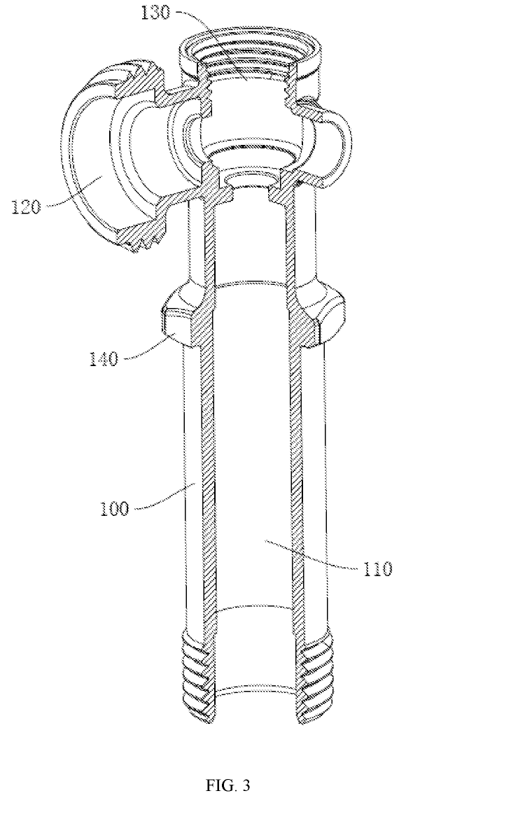

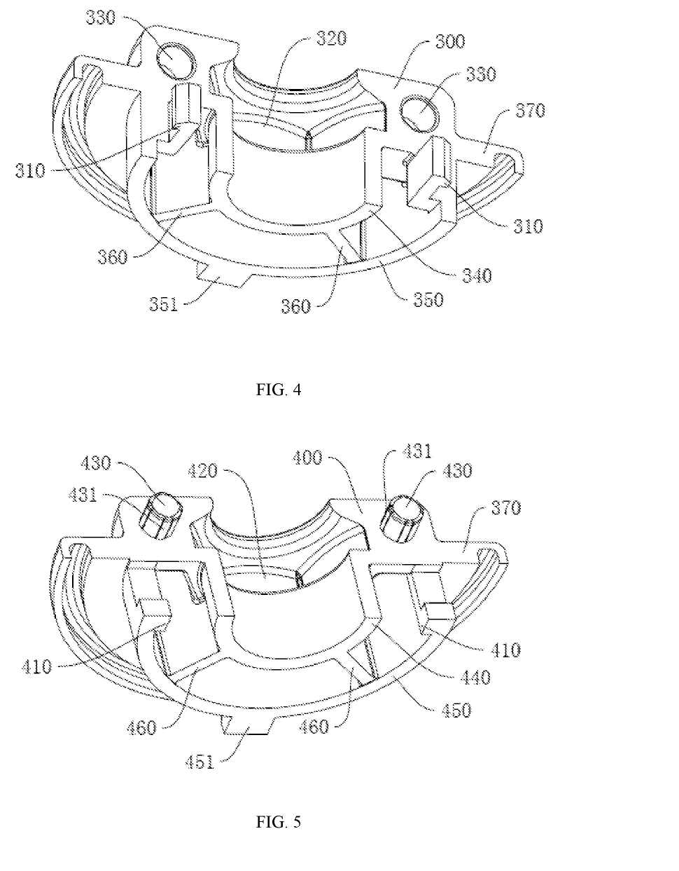

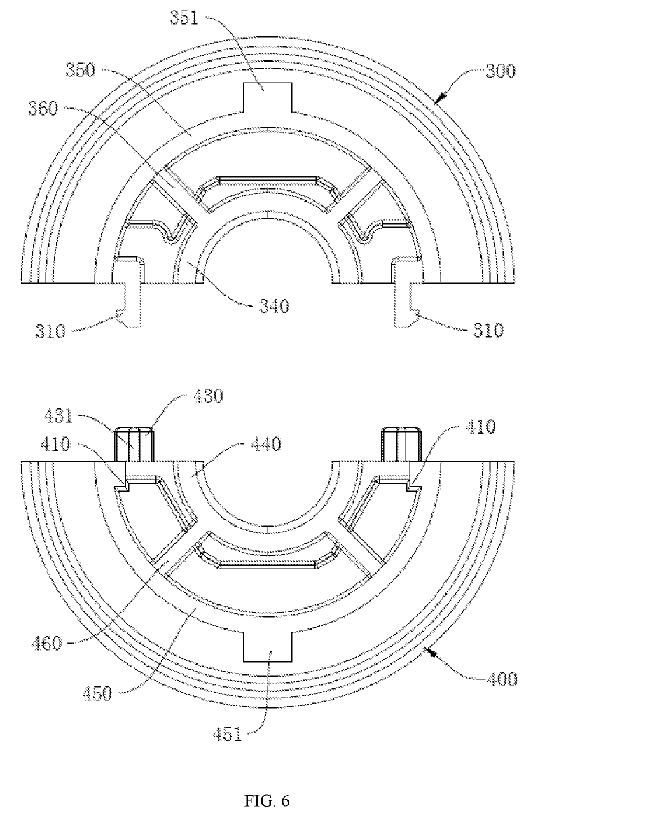

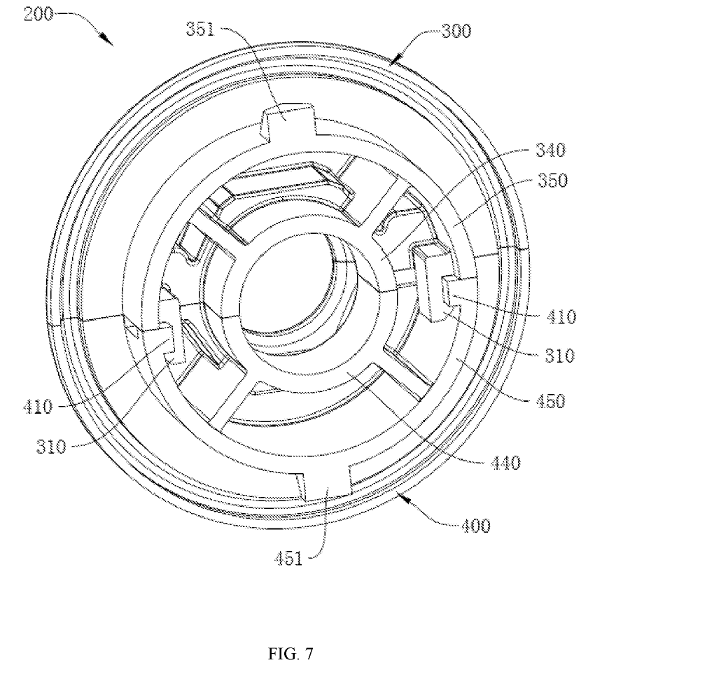

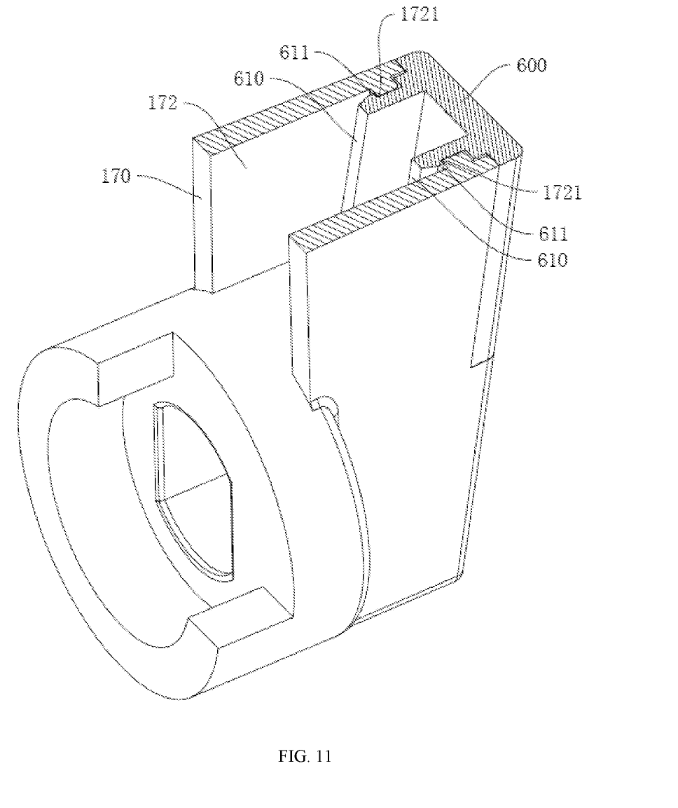

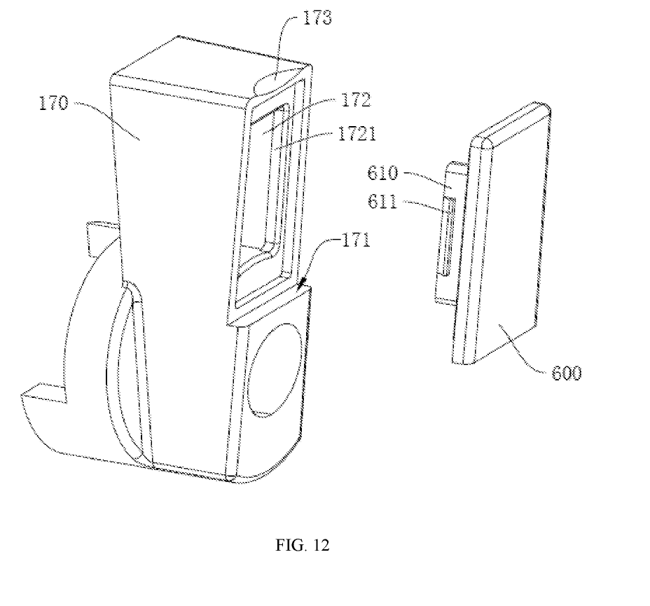

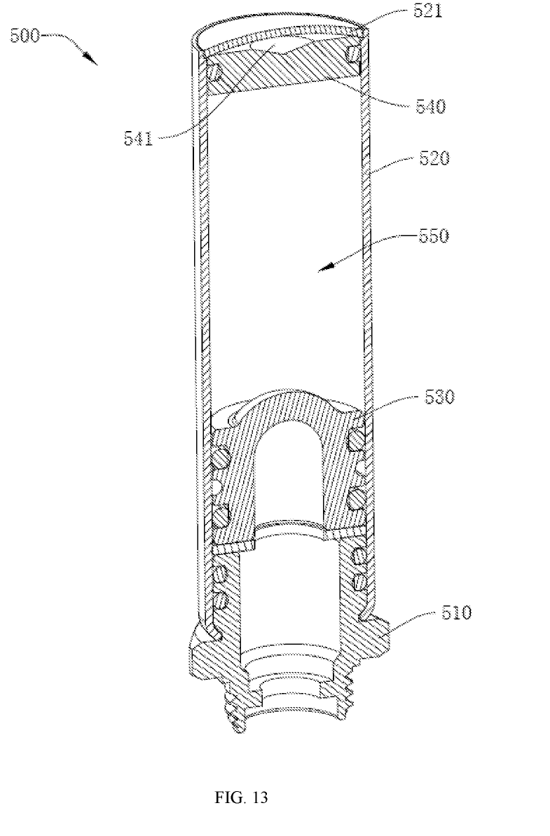

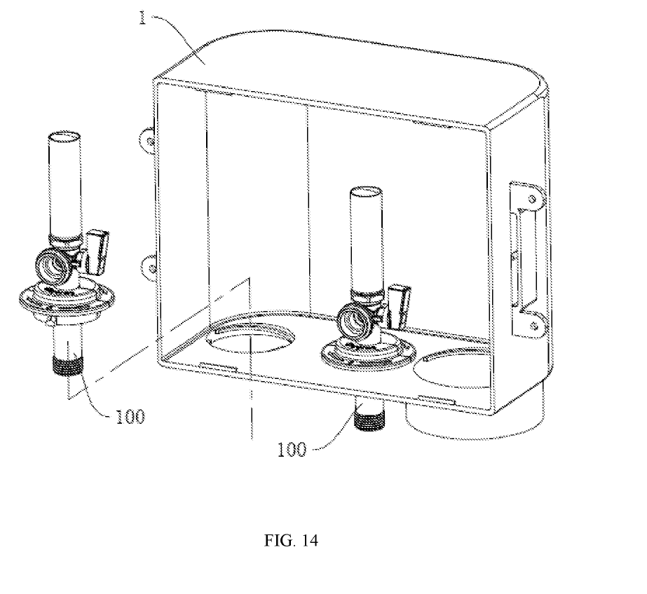

An angle valve for a washing machine supply and drain box, as shown in FIG. 1 to FIG. 14, includes a valve body 100. The valve body 100 has a water inlet 110, a water outlet 120 and a mounting opening 130. The mounting opening 130 is in communication with both the water inlet 110 and the water outlet 120. An outside of the valve body 100 has an angular protrusion 140. A mounting cover 200 is arranged outside the protrusion 140. The mounting cover 200 is configured to connect the valve body 100 to an inside of a washing machine supply and drain box 1. The mounting cover 200 includes a cover plate I 300 and a cover plate II 400 that are detachably connected. The cover plate I 300 is provided with two snap-fit protrusions 310, and the cover plate II 400 is provided with two limit blocks 410 adapted to the two snap-fit protrusions 310. The snap-fit protrusions 310 and the limit blocks 410 are snap-fitted to combine the cover plate I 300 and the cover plate II 400 into a whole, and the cover plate I 300 and the cover plate II 400 are fitted to limit the protrusion 140.

Specifically, an inside of the cover plate I 300 has a groove I 320, and an inside of the cover plate II 400 has a groove II 420. The groove I 320 and the groove II 420 are in communication with each other. Side walls of the groove I 320 and the groove II 420 are adapted to an exterior shape of the protrusion 140. The cover plate I 300 and the cover plate II 400 are combined to clamp the protrusion 140, and the groove I 320 and the groove II 420 are fitted to limit the protrusion 140 axially and circumferentially. That is, upper and lower sides of the protrusion 140 are both be closely surrounded and attached by the groove I 320 and the groove II 420, and the mounting cover 200 cannot rotate relative to the protrusion 140 or slide up and down, so that the mounting cover 200 can completely limit the valve body 100.

As shown in FIG. 1 to FIG. 9, a side surface of the cover plate I 300 is provided with at least one positioning groove 330. The cover plate II 400 is provided with a positioning column 430 adapted to the positioning groove 330. A number of the positioning columns 430 is in one-to-one correspondence to a number of the positioning grooves 330. The positioning column 430 is inserted into the positioning groove 330 to limit the cover plate I 300 and the cover plate II 400, thereby preventing the cover plate I 300 and the cover plate II 400 from dislocation after being connected, ensuring the snap-fit protrusions 310 and the limit blocks 410 to be snap-fitted more stably, and providing better stability between the cover plate I 300 and the cover plate II 400 after being connected.

At least two convex ribs 431 are circumferentially distributed on an outer wall of the positioning column 430. A length direction of the convex ribs 431 is the same as a length direction of the positioning column 430. After the positioning column 430 is inserted into the positioning groove 330, the positioning column 430 abuts against a wall of the positioning groove 330 through the convex ribs 431, thereby ensuring that the convex ribs 431 and the positioning groove 330 achieve an interference fit and preventing the cover plate I 300 and the cover plate II 400 from shaking or looseness after being connected.

A lower end of the cover plate I 300 has a half ring I 340, and a lower end of the cover plate II 400 has a half ring II 440. The half ring I 340 and the half ring II 440 are configured to be fitted to form a complete circular ring. Inner sides of both the half ring I 340 and the half ring II 440 are configured to abut against an outer wall of the valve body 100, thereby further preventing the mounting cover 200 from shaking relative to the valve body 100.

An outer side of the half ring I 340 is provided with a half ring III 350, and an outer side of the half ring II 440 is provided with a half ring IV 450. Ribs I 360 are arranged between the half ring I 340 and the half ring III 350, and ribs II 460 are arranged between the half ring II 440 and the half ring IV 450. The ribs I 360 are configured to increase a structural strength of the cover plate I 300. The ribs II 460 are configured to increase a structural strength of the cover plate II 400. The snap-fit protrusions 310 are located on the half ring III 350, and the limit blocks 410 are located on the half ring IV 450. An outer wall of the half ring III 350 is provided with a wedge I 351, and an outer wall of the half ring IV 450 is provided with a wedge II 451. The outer sides of both the cover plate I 300 and the cover plate II 400 are provided with a flange 370. The mounting cover 200 is connected to the inside of the washing machine supply and drain box 1 through the wedge I 351 and the wedge II 451. The two flanges 370 abut against an inner wall of the washing machine supply and drain box 1. That is, the flanges 370 are fitted with the wedge I 351 and the wedge II 451 to firmly connect the mounting cover 200 to side walls of the washing machine supply and drain box 1, such that the mounting cover 200 is connected to the washing machine supply and drain box 1.

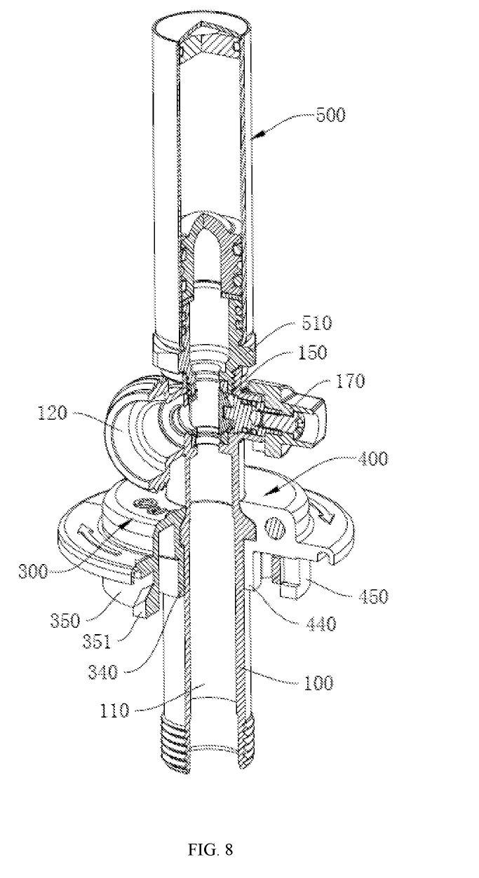

As shown in FIG. 8 to FIG. 9 and FIG. 13, a water hammer arrestor 500 is arranged in the mounting opening 130. The water hammer arrestor 500 includes a connector 510, a casing 520 and a piston 530. The connector 510 is arranged in the mounting opening 130. A lower end of the casing 520 is connected to the connector 510, and the connector 510 communicates the lower end of the casing 520 with an inside of the valve body 100. An upper end of the casing 520 is sealed by an end cover 521. The end cover 521 and an inside of the casing 520 are sealed by a sealing gasket 540. A top of the sealing gasket 540 has an accommodating groove 541. The piston 530 is slidably arranged at a lower end inside the casing 520. A cushioning member 550 is arranged between the piston 530 and the sealing gasket 540. The cushioning member 550 is a gas. In some implementations, the cushioning member 550 is a spring. There is an occasional gap between the end cover 521 and the casing 520 during welding, and the sealing gasket 540 seals the weld between the end cover 521 and the casing 520, which can maintain long-term air tightness inside the casing 520.

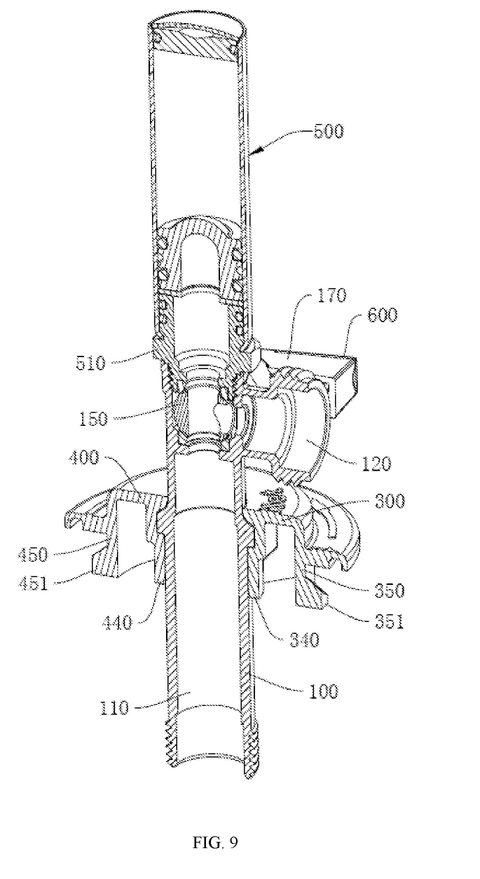

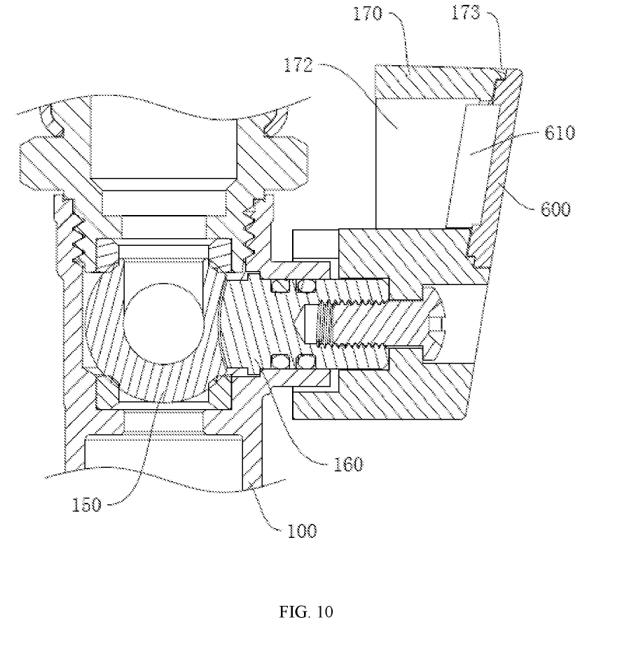

A ball core 150 is rotatably arranged in the valve body 100. The ball core 150 is a three-way ball core. As shown in FIG. 8 and FIG. 9, when the angle valve is open, the ball core 150 communicates the water inlet 110, the water outlet 120 and the connector 510. As shown in FIG. 10, when the angle valve is closed, the ball core 150 communicates the water outlet 120 and the connector 510. That is, the ball core 150 always keeps the water outlet 120 in communication with the inside of the water hammer arrestor 500.

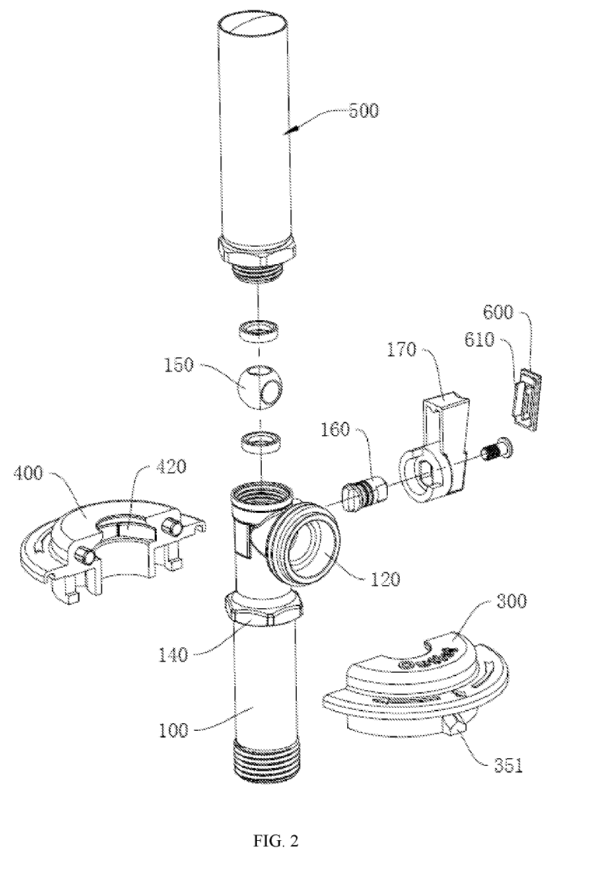

As shown in FIG. 2 and FIG. 8 to FIG. 10, the ball core 150 is provided with a valve stem 160. An outer end of the valve stem 160 runs through the valve body 100 and is connected to a grip 170. The grip 170 is configured to drive the ball core 150 to rotate, thereby controlling the valve angle to be open or closed. The grip 170 is detachably connected to an identification card 600. The identification card 600 is configured to mark a type of a medium in the valve body 100. Different colors of identification cards 600 are used to distinguish the type of supplied water of the corresponding angle valve. In this embodiment, the medium in the valve body 100 is mainly cold water or hot water, and the identification card 600 functions to distinguish whether cold water or hot water is supplied in the valve body 100, so that the user can accurately control the corresponding angle valve.

The grip 170 has an assembly groove 171 and an assembly hole 172 that are in communication with each other. A wall of the assembly hole 172 has a bump 1721. The bump 1721 may be annular. The assembly groove 171 is filled with the identification card 600. An inner side of the identification card 600 is provided with at least one snap-fit foot 610 capable of elastic deformation. The snap-fit foot 610 has a snap-fit hook 611. After the snap-fit foot 610 is inserted into the assembly hole 172, the snap-fit hook 611 is snap-fitted with the bump 1721 and limits the identification card 600.

Further, the identification card 600 sinks into the assembly groove 171, and an outer wall of the identification card 600 is flush with an outer wall of the grip 170, which prevents the identification card 600 from protruding and affecting the user to control the grip 170. A side of the grip 170 close to the identification card 600 is provided with a notch 173, and the notch 173 is configured to be inserted by a tool or a nail of a user, so that the user can take the identification card 600 from the assembly groove 171.

The working principle of the present disclosure is as follows:

During the assembly, the cover plate I 300 is attached to the outer wall of the valve body 100, so that the protrusion 140 enters the groove I 320. Then, the positioning column 430 on the cover plate II 400 is aligned with the positioning groove 330, and the cover plate II 400 is pressed hard against the cover plate I 300, so that the two snap-fit protrusions 310 can be accurately snap-fitted with the corresponding limit blocks 410. Therefore, the cover plate I 300 and the cover plate II 400 can clamp the protrusion 140. Alternatively, the cover plate I 300 and the cover plate II 400 may be reversed and then assembled. In this case, the inner walls of both the half ring I 340 and the half ring II 440 abut against the outer wall of the valve body 100, and the mounting cover 200 formed by the cover plate I 300 and the cover plate II 400 completely limits the protrusion 140, so that the valve body 100 and the mounting cover 200 can be subjected to subsequent mounting as a whole component. The mounting cover 200 is connected to the inside of the washing machine supply and drain box 1, thereby realizing the mounting of the angle valve.

Two angle valves are mounted in the washing machine supply and drain box 1. One of the angle valves is configured to supply cold water, and the other angle valve is configured to supply hot water. Different colors of the identification cards 600 are used to distinguish the type of supplied water in the two angle valves. For example, a blue identification card 600 corresponds to a valve body 100 for supplying cold water, and a red identification card 600 corresponds to a valve body 100 for supplying hot water.

If the worker mistakenly connects the valve body 100 with the blue identification card to a hot water pipe and the valve body 100 with the red identification card to a cold water pipe, the worker only needs to remove the blue identification card and the red identification card from the grips 170, and then mount the blue identification card to the grip 170 of the angle valve connected to the cold water pipe and the red identification card to the grip 170 of the angle valve connected to the hot water pipe, so that the colors of the identification cards 600 respectively correspond to the type of the supplied water in the angle valve. There is no need to dismount and mount the two angle valves again, thereby effectively making up for the influence on routine operation brought to users by the workers' mistaken mounting.

The above description is only exemplary implementations of the disclosure, and is not intended to limit the protection scope of the present disclosure. The protection scope of the present disclosure is determined by the appended claims.

What is claimed is:

1. An angle valve for a washing machine supply and drain box, comprising a valve body (100), the valve body (100) having a water inlet (110) and a water outlet (120), wherein
an outside of the valve body (100) has a protrusion (140), a mounting cover (200) is arranged outside the protrusion (140), the mounting cover (200) is configured to connect the valve body (100) to an inside of a washing machine supply and drain box (1), the mounting cover (200) comprises a cover plate I (300) and a cover plate II (400) that are detachably connected, the cover plate I (300) is provided with two snap-fit protrusions (310), the cover plate II (400) is provided with two limit blocks (410) adapted to the two snap-fit protrusions (310), the snap-fit protrusions (310) and the limit blocks (410) are configured to be fitted to limit the cover plate I (300) and the cover plate II (400), and the cover plate I (300) and the cover plate II (400) are fitted to limit the protrusion (140).

2. The angle valve for a washing machine supply and drain box (1) according to claim 1, wherein an inside of the cover plate I (300) has a groove I (320), an inside of the cover plate II (400) has a groove II (420), side walls of the groove I (320) and the groove II (420) are adapted to an exterior shape of the protrusion (140), the cover plate I (300) and the cover plate II (400) are combined to clamp the protrusion (140), and the groove I (320) and the groove II (420) are fitted to limit the protrusion (140).

3. The angle valve for a washing machine supply and drain box (1) according to claim 1, wherein a side surface of the cover plate I (300) is provided with at least one positioning groove (330), the cover plate II (400) is provided with a positioning column (430) adapted to the positioning groove (330), and the positioning column (430) is inserted into the positioning groove (330) to limit the cover plate I (300) and the cover plate II (400).

4. The angle valve for a washing machine supply and drain box (1) according to claim 3, wherein at least two convex ribs (431) are circumferentially distributed on an outer wall of the positioning column (430), and the positioning column (430) abuts against a wall of the positioning groove (330) through the convex ribs (431).

5. The angle valve for a washing machine supply and drain box (1) according to claim 1, wherein a lower end of the cover plate I (300) has a half ring I (340), a lower end of the cover plate II (400) has a half ring II (440), and inner sides of both the half ring I (340) and the half ring II (440) are configured to abut against an outer wall of the valve body (100).

6. The angle valve for a washing machine supply and drain box (1) according to claim 5, wherein an outer side of the half ring I (340) is provided with a half ring III (350), an outer side of the half ring II (440) is provided with a half ring IV (450), ribs I (360) are arranged between the half ring I (340) and the half ring III (350), and ribs II (460) are arranged between the half ring II (440) and the half ring IV (450); and an outer wall of the half ring III (350) is provided with a wedge I (351), and an outer wall of the half ring IV (450) is provided with a wedge II (451).

7. The angle valve for a washing machine supply and drain box (1) according to claim 1, wherein the valve body (100) is further provided with a mounting opening (130) in communication with the water inlet (110) and the water outlet (120), a water hammer arrestor (500) is arranged in the mounting opening (130), the water hammer arrestor (500) comprises a connector (510), a casing (520) and a piston (530), the connector (510) is arranged in the mounting opening (130), a lower end of the casing (520) is connected to the connector (510), the connector (510) communicates the lower end of the casing (520) with an inside of the valve body (100), an upper end of the casing (520) is sealed by an end cover (521), the end cover (521) and an inside of the casing (520) are sealed by a sealing gasket (540), the piston (530) is slidably arranged in the casing (520), and a cushioning member (550) is arranged between the piston (530) and the sealing gasket (540).

8. The angle valve for a washing machine supply and drain box (1) according to claim 1, wherein a ball core (150) is rotatably arranged in the valve body (100), the ball core (150) is provided with a valve stem (160), an outer end of the valve stem (160) runs through the valve body (100) and is connected to a grip (170), the grip (170) is detachably connected to an identification card (600), and the identification card (600) is configured to mark a type of a medium in the valve body (100).

9. The angle valve for a washing machine supply and drain box (1) according to claim 8, wherein the grip (170) has an assembly groove (171) and an assembly hole (172) that are in communication with each other, a wall of the assembly hole (172) has a bump (1721), the assembly groove (171) is filled with the identification card (600), an inner side of the identification card (600) is provided with a snap-fit foot (610), the snap-fit foot (610) has a snap-fit hook (611), and after the snap-fit foot (610) is inserted into the assembly hole (172), the snap-fit hook (611) is snap-fitted with the bump (1721) and limits the identification card (600).

10. The angle valve for a washing machine supply and drain box (1) according to claim 9, wherein an outer wall of the identification card (600) is flush with an outer wall of the grip (170), a side of the grip (170) close to the identification card (600) is provided with a notch (173), and the notch (173) is configured to be inserted by a tool or a nail of a user.
